(19) United States
(12) Patent Application Publication
(10) Pub. No.: US 2024/0368334 A1
(43) Pub. Date: Nov. 7, 2024

(54) PRODUCTION OF RIGID POLYURETHANE OR POLYISOCYANURATE FOAM

(71) Applicant: Evonik Operations GmbH, Essen (DE)

(72) Inventors: Martin GLOS, Borken (DE); Jörg Diendorf, Essen (DE)

(73) Assignee: Evonik Operations GmbH, Essen (DE)

(21) Appl. No.: 18/575,863

(22) PCT Filed: Jun. 13, 2022
(86) PCT No.: PCT/EP2022/065981

§ 371 Date: Jan. 1, 2024

(30) Foreign Application Priority Data
Jul. 1, 2021 (EP) 21183094.8

(51) Int. Cl. C08G 18/28; C08G 18/30; C08G 18/48

(52) U.S. Cl. CPC C08G 18/283; C08G 18/2835; C08G 18/302; C08G 18/4829; C08G 2110/0025; C08G 2110/0083

(57) ABSTRACT

A process for producing a rigid PU or PIR foam can be performed by contacting at least one organic polyisocyanate having two or more isocyanate functions with an isocyanate-reactive mixture. The isocyanate-reactive mixture has at least one polyol, water and at least one emulsifier, wherein the emulsifier has at least one alkoxylated aromatic alcohol. The parent aromatic alcohol has at least 6 and at most 40 carbon atoms and also at least one OH function. At most ⅕ of the carbon atoms of the parent aromatic alcohol are not aromatic, and at least one aromatic unit in the parent aromatic alcohol must bear an OH function.

The present invention is in the field of polyurethanes (PU) and polyisocyanurates (PIR), especially of rigid PU or PIR foams. More particularly, it relates to the production of rigid PU or PIR foams using specific emulsifiers, and additionally to the use of the foams which have been produced therewith. The present invention concerns rigid PU or PIR foams.

Polyurethane (PU) in the context of the present invention is especially understood to mean a product obtainable by reaction of polyisocyanates and polyols. In addition to the polyurethane, further functional groups may also be formed in the reaction, for example uretdiones, carbodiimides, isocyanurates, allophanates, biurets, ureas and/or uretonimines. PU is therefore for the purposes of the present invention understood as meaning not just polyurethane, but also polyisocyanurate, polyureas, and polyisocyanate reaction products containing uretdione, carbodiimide, allophanate, biuret and uretonimine groups. Polyimides are not included.

In the context of the present invention, polyurethane foam (PU foam) is especially understood to mean foam which is obtained as reaction product based on polyisocyanates and polyols. In addition to the eponymous polyurethane, further functional groups can be formed as well, examples being allophanates, biurets, ureas, carbodiimides, uretdiones, isocyanurates or uretonimines.

Polyisocyanurate foam (PIR foam), especially rigid polyisocyanurate foams, have likewise long been known and described in the prior art. They are typically likewise produced by reaction of polyisocyanates with polyols, preferably polyester polyols and polyether polyols, the isocyanate index preferably being 180 or more. Urethane structures are formed in the process, arising as a result of the reaction of isocyanates with compounds having reactive hydrogen atoms, and, via reaction of the isocyanate groups with one another, there is additionally also formation of isocyanurate structures or further structures that result from the reaction of isocyanate groups with other groups, for example polyurethane groups.

The present invention more particularly concerns the composition of the polyols or isocyanate-reactive mixture to be used. One or more blowing agents are preferably added to the isocyanate-reactive mixture.

Blowing agents are either chemically reactive, such as for example water or formic acid, or are physical blowing agents which evaporate during the reaction due to their boiling point and as a result lead or contribute to foam expansion. Physical blowing agents are hydrocarbons, halogenated hydrocarbons, etc. This is known.

It is often the case that the blowing agents are only miscible to a limited extent in the isocyanate-reactive mixture, and thus when producing the mixture a clear component is not obtained but instead a cloudy emulsion, which in turn is also accompanied by the problem of phase separation. That is to say that in many cases the blowing agent separates out. Since the isocyanate-reactive mixture can often also contain further constituents of the overall reaction mixture, aside from the isocyanate, i.e. flame retardants, catalysts, optionally dyes, stabilizers, optionally cell regulators, etc., such a phase separation is especially detrimental.

In order to avoid this clouding or phase separation problem, various emulsifiers may be used. Various publications concerning the use of emulsifiers for improving the stability of the isocyanate-reactive mixture containing blowing agents are known.

U.S. Pat. No. 6,262,136 B1 describes polyol mixtures containing fluorine-containing blowing agents which are gaseous at standard pressure. In this document, phenols or alkylphenols are used in order to solubilize the blowing agent in the polyol. The blowing agents are HFC 134, HCFC-124, HCFC-22.

U.S. Pat. No. 9,290,604 uses mixtures of alkyl ethoxylates as emulsifiers in a water-blown reaction mixture for the production of PU foam.

The use of alkyl ethoxylates as emulsifiers for immiscible polyols is described in WO 2018/089768, flexible foams being produced from the reaction mixture here.

U.S. Pat. No. 9,290,604 uses ethoxylated nonylphenols as emulsifiers in a water-blown reaction mixture for the production of PU foam.

Ethoxylated nonylphenols are also described in DE 3632915 in PU formulations containing halogenated blowing agents.

WO 2020/231603 describes the use of nonionic surfactants for improving the storage stability of polyol mixtures consisting of polyester polyols and hydrocarbons as blowing agents. The surfactants are alkyl ethoxylates or block copolymers based on various alkylene oxides.

U.S. Pat. No. 4,595,711 describes the use of nonylphenol alkoxylates in order to facilitate the use of halogenated blowing agents or to improve the solubility/emulsifiability thereof in the polyol mixture.

It was an object of the present invention to make it possible to provide isocyanate-reactive mixtures having improved storage stability and to use these for the production of rigid polyurethane or polyisocyanurate foams.

Surprisingly, it has now been found that the use of alkoxylates based on certain aromatic alcohols such as, for example, phenols or naphthols, makes it possible to achieve this object.

The subject matter of the invention which achieves the aforesaid object is a process for producing a rigid PU or PIR foam, comprising the contacting of at least one isocyanate with an isocyanate-reactive mixture comprising at least one polyol, water and at least one emulsifier, wherein one or more organic polyisocyanates having two or more isocyanate functions are used as isocyanates, characterized in that the emulsifier comprises at least one alkoxylated aromatic alcohol, in which the parent aromatic alcohol has at least 6 and at most 40 carbon atoms and also at least one OH function, and in which at most ⅕ of the carbon atoms of the parent aromatic alcohol are not aromatic, and wherein at least one aromatic unit in the parent aromatic alcohol must bear an OH function.

The emulsifiers according to the invention are therefore alkoxylates of certain aromatic alcohols. “Parent aromatic alcohol” means that the latter after alkoxylation leads to the “alkoxylated aromatic alcohol”.

According to a preferred embodiment of the invention, the aromatic alcohol is ethoxylated.

A suitable, usable structure of the alkoxylated aromatic alcohol is based on phenol as starter alcohol (=parent aromatic alcohol) and has the following structure:

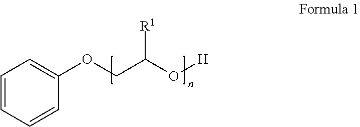

Here, R¹ is hydrogen, methyl, ethyl or phenyl. Therefore, ethylene oxide, propylene oxide, butylene oxide or styrene oxide may preferably be used for the alkoxylation.

n is a number from 2 to 200, preferably from 3 to 150, particularly preferably from 4 to 100.

In a further preferred embodiment of the invention, ethoxylates of the aromatic alcohols are used. This is illustrated here using phenol:

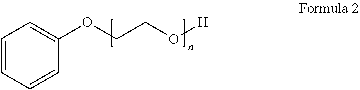

The parent starter alcohols are based on aromatic alcohols such as, for example, benzene having one or more OH functions: preferably phenol, pyrocatechol or resorcinol:

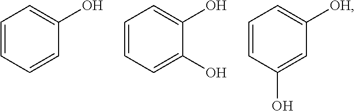

such as, for example, polycyclic aromatic systems having OH functions: preferably 1-naphthol or 2-naphthol

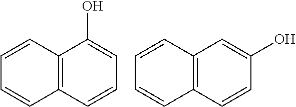

such as, for example linked aromatic systems: preferably cumylphenol, biphenol, bisphenol A or bisphenol F

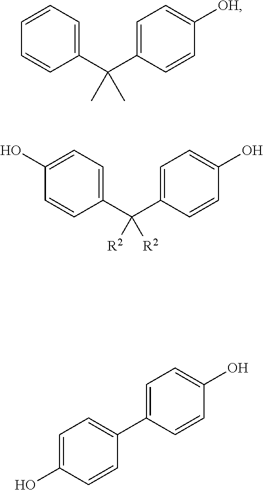

with R²=methyl or hydrogen,
or such as, for example, styrenized phenols: preferably mono-, di- or tristyrylphenol.

Illustrated here by way of example are: 2,4,6-tris(1-phenylethyl)phenol, 2,4-bis(1-phenylethyl)phenol and p-(1-phenylethyl)phenol,

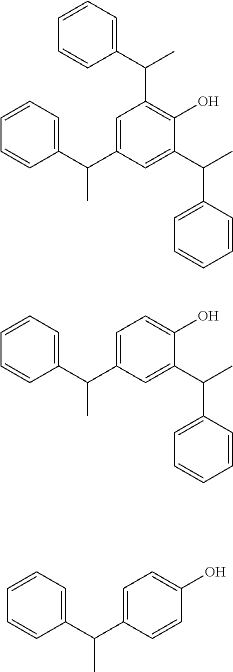 [SMILES: CC(c1ccccc1)c1cc(C(C)c2ccccc2)c(O)c(C(C)c2ccccc2)c1 ; CC(c1ccccc1)c1ccc(O)c(C(C)c2ccccc2)c1 ; CC(c1ccccc1)c1ccc(O)cc1]

wherein further isomers which result from the reaction of styrene with phenol may also be used.

At least one aromatic unit in the parent aromatic alcohol must bear an OH function. The parent aromatic alcohol may contain 6 to 40 carbon atoms. In this case, it is also possible for conjugated (polycyclic) aromatic systems (naphthalene) to be present or for two or more aromatic systems to be linked with one another (bisphenol), where at most ⅕ of the carbon atoms of the parent aromatic alcohol are not aromatic.

The numerical ratio of the carbon atoms in the starter alcohols shall be explained here by way of example: In the above-illustrated structural formula of tristyrylphenol, there are a total of 30 carbon atoms, of which 6 are not aromatic and 24 carbon atoms are aromatic. It emerges from this that ⅕ of the carbon atoms are not aromatic.

The maximum number of carbon atoms in the parent aromatic alcohol is 40, preferably 35, more preferably 30.

Preferably, more than 6 carbon atoms are present in the parent aromatic alcohol, particularly preferably more than 8.

Preference is given to alkoxylates of monoalcohols such as tristyrylphenols, naphthols or phenols. Particular preference is given to alkoxylates of naphthols.

The proportion of ethylene oxide in the polyether chain is preferably greater than 80%, or greater than 90%, based on the overall alkylene oxide. Particular preference is given to pure ethoxylates.

In a preferred embodiment of the invention, the alkoxylated aromatic alcohols are based on
(i) monocyclic aromatic alcohols having one or more OH functions, preferably phenol, pyrocatechol or resorcinol,
(ii) polycyclic aromatic systems having one or more OH functions, preferably 1-naphthol or 2-naphthol.
(iii) linked aromatic systems having one or more OH functions, preferably biphenol, bisphenol A, bisphenol F or cumylphenol and/or
(iv) styrenized phenols, preferably 2,4,6-tris(1-phenylethyl)phenol, 2,4-bis(1-phenylethyl)phenol or p-(1-phenylethyl)phenol.

In a further preferred embodiment of the invention, the alkoxylated aromatic alcohol used has 4 to 100 alkoxy groups per molecule.

In a preferred embodiment of the invention, the alkoxylated aromatic alcohol used has a calculated HLB value of greater than 10, especially greater than 12, in particular greater than 14. A suitable upper limit is 20.

HLB values and the calculation thereof are known per se: emulsifiers are typically composed of a combination of hydrophilic and lipophilic structural elements. Thus, for example, in alcohol ethoxylates the hydroxy-terminated polyether portion can be considered to be the hydrophilic structural element and the starter alcohol can be considered to be the lipophilic structural element. The “hydrophilic-lipophilic balance”, also called the HLB value, results from the molar mass proportions of the respective structural elements. This can then be calculated according to the following formula:

$$H L B = \frac{\% by weight of the hydrophilic structural element}{5}$$

HLB values generally vary within the range from 1 to 20. The higher the proportion of hydrophilic structural elements, the higher the HLB value as well. Different emulsifiers can thus be compared with one another.

This method is very readily usable for ethoxylates by dividing the respective percentage proportion by weight of ethylene oxide units by 5. Thus, for example, ethoxylates based on fatty alcohols, nonylphenols and also the alcohol ethoxylates according to the invention can be compared with one another according to their HLB value.

It is also possible to use mixtures of the emulsifiers according to the invention. In a preferred embodiment of the invention, at least two alkoxylated aromatic alcohols are used, preferably comprising ethoxylated phenol(s) and ethoxylated naphthol(s).

It is a further preferred embodiment of the invention when the isocyanate-reactive mixture contains 2% to 30% by mass of water and 1% to 30% by mass of emulsifier and, if any, less than 3% by mass of nonylphenol ethoxylate. These % by mass values are based on the sum of all components used which are not organic polyisocyanates.

It is also a further preferred embodiment of the invention when the isocyanate-reactive mixture comprises flame retardants.

It is also a further preferred embodiment of the invention when the isocyanate-reactive mixture comprises at least one catalyst.

It is likewise a preferred embodiment of the invention, when the emulsifiers according to the invention are added to the reaction mixture in a carrier medium or solvent.

The emulsifier according to the invention is thus preferably usable as an emulsifier-containing formulation. An emulsifier-containing formulation may therefore also contain carrier media or solvents. These include in particular glycols, other alkoxylates and/or oils of synthetic and/or natural origin. Up to 15% water may also preferably be present in the emulsifier-containing formulation. “Other alkoxylates” means that these alkoxylates do not come under the definition of the alkoxylated aromatic alcohols according to the invention.

In principle, carrier media used may be any substances suitable as solvent. Preferred examples include glycols, other alkoxylates and/or oils of synthetic and/or natural origin. It is possible to use protic or aprotic solvents. The emulsifier-containing formulations according to the invention may also be used as part of compositions with different carrier media.

The invention further provides an emulsifier-containing formulation, comprising
(a) at least one, preferably at least two, alkoxylated aromatic alcohol(s) according to the invention and as defined above, in amounts of from 20% to <100% by weight, preferably 25% to 95% by weight, particularly preferably 30% to 90% by weight,
(b) water in amounts of from 0% to 30% by weight, preferably 1% to 20% by weight, particularly preferably 2% to 10% by weight,
(b) carrier media in amounts of from 0% to 80% by weight, preferably 5% to 75% by weight, particularly preferably 10% to 70% by weight,
with the proviso that the sum total of (b) and (c) is >0% by weight.

The invention further provides a composition comprising an isocyanate-reactive mixture which comprises at least one polyol, water and at least one, preferably at least two, alkoxylated aromatic alcohol(s) according to the invention and as defined above, wherein the isocyanate-reactive mixture contains 2% to 30% by mass of water and 1% to 30% by mass of emulsifier and, if any, less than 3% by mass of nonylphenol ethoxylates, and optionally, preferably mandatorily, contains flame retardants. These % by mass values are based on the sum of all components used which are not organic polyisocyanates.

The invention further provides a composition for producing rigid polyurethane or polyisocyanurate foam, comprising an isocyanate component and an isocyanate-reactive mixture, optionally a foam stabilizer, a blowing agent, a catalyst, wherein the composition contains at least one emulsifier which preferably improves the storage stability of the isocyanate-reactive mixture, wherein the emulsifier comprises at least one alkoxylated aromatic alcohol, in which the parent aromatic alcohol has at least 6 and at most 40 carbon atoms and also at least one OH function, and in which at most ⅕ of the carbon atoms of the parent aromatic alcohol are not aromatic.

With the solution according to the invention, it is thus possible to produce rigid PU or PIR foam-based products, for example building insulation, with very particularly high quality, and to make the processes for producing the rigid PU or PIR foams more efficient.

Preferred applications are primarily spray foam, which after application may be open-cell or closed-cell, preferably open-cell.

The emulsification of water is an important object in particular for open-cell spray foam, since here large amounts of water are generally used as blowing agent.

In a preferred embodiment of the invention, the total proportion by mass of emulsifiers according to the invention in the finished polyurethane foam is from 0.05% to 20% by weight, preferably from 0.1% to 15% by weight.

In a preferred embodiment of the invention, the composition according to the invention comprises water and/or blowing agents, optionally at least one flame retardant and/or further additives that are advantageously usable in the production of rigid polyurethane or polyisocyanurate foam.

A particularly preferred composition according to the invention contains the following constituents:
a) isocyanate-reactive compounds, especially polyols,
b) at least one polyisocyanate and/or polyisocyanate prepolymer,
c) at least one, preferably two, emulsifier(s) according to the invention and as described above,
d) catalysts, (optionally) a foam-stabilizing component based on siloxanes or other surfactants,
f) one or more blowing agents,
g) further (optional) additives such as flame retardants, fillers, etc.

Here, the components a), c), d), e), f) and g) may form the constituents of the isocyanate-reactive mixture comprising at least one emulsifier according to the invention, as defined above.

The invention further provides for the use of emulsifiers and/or emulsifier-containing formulations according to the invention, especially using a composition according to the invention as described above, as emulsifier for the isocyanate-reactive mixture in the production of rigid polyurethane or polyisocyanurate foams, preferably for improving the storage stability of the isocyanate-reactive mixture and consequently the use properties thereof for the production of rigid polyurethane or polyisocyanurate foams.

The invention further provides for the use of a, preferably of at least two, alkoxylated aromatic alcohol(s) as defined above as emulsifiers for improving the storage stability of isocyanate-reactive mixtures comprising polyols, water and optionally flame retardants.

The invention further provides a rigid polyurethane or polyisocyanurate foam produced by the process according to the invention; this is preferably an open-cell, water-blown spray foam.

Individual usable constituents (identified here as a) to g)) which may be used within the context of the invention will be described in more detail hereinbelow. The constituent c), emulsifiers according to the invention, has already been described in detail.

Suitable isocyanate-reactive compounds a) are in particular polyols. Polyols suitable for the purposes of the present invention are all organic substances having two or more isocyanate-reactive groups, preferably OH groups, and also formulations thereof. Preferred polyols are all polyether polyols and/or polyester polyols and/or hydroxyl-containing aliphatic polycarbonates, in particular polyether polycarbonate polyols, and/or polyols of natural origin, known as “natural oil-based polyols” (NOPs), that are customarily used for producing polyurethane systems, especially polyurethane coatings, polyurethane elastomers or foams. The polyols typically have a functionality of preferably from 1.8 to 8 and number-average molecular weights preferably in the range from 500 to 15 000. It is customary to employ polyols having OH numbers in the range from 10 to 1200 mg KOH/g.

It is possible to use polyether polyols, for example. These can be prepared by known methods, for example by anionic polymerization of alkylene oxides in the presence of alkali metal hydroxides, alkali metal alkoxides or amines as catalysts and by addition of at least one starter molecule which preferably contains 2 or 3 reactive hydrogen atoms in bonded form, or by cationic polymerization of alkylene oxides in the presence of Lewis acids, for example antimony pentachloride or boron trifluoride etherate, or by double metal cyanide catalysis. Suitable alkylene oxides contain 2 to 4 carbon atoms in the alkylene radical. Examples are tetrahydrofuran, 1,3-propylene oxide and 1,2- or 2,3-butylene oxide; preference is given to using ethylene oxide and 1,2-propylene oxide. The alkylene oxides may be used individually, cumulatively, in blocks, in alternating succession or as mixtures. Starter molecules used may in particular be compounds having at least 2, preferably 2 to 8, hydroxyl groups, or having at least two primary amino groups in the molecule. Starter molecules used may, for example, be water, di-, tri- or tetrahydric alcohols such as ethylene glycol, propane-1.2- and -1,3-diol, diethylene glycol, dipropylene glycol, glycerol, trimethylolpropane, pentaerythritol, castor oil, etc., higher polyfunctional polyols, especially sugar compounds, for example glucose, sorbitol, mannitol and sucrose, polyhydric phenols, resols, for example oligomeric condensation products of phenol and formaldehyde and Mannich condensates of phenols, formaldehyde and dialkanolamines, and also melamine, or amines such as aniline, EDA, TDA, MDA and PMDA, more preferably TDA and PMDA. The choice of the suitable starter molecule is dependent on the respective field of application of the resulting polyether polyol in the production of polyurethane.

It is possible to use polyester polyols, for example. These are based on esters of polybasic aliphatic or aromatic carboxylic acids, preferably having 2 to 12 carbon atoms. Examples of aliphatic carboxylic acids are succinic acid, glutaric acid, adipic acid, suberic acid, azelaic acid, sebacic acid, decanedicarboxylic acid, maleic acid and fumaric acid. Examples of aromatic carboxylic acids are phthalic acid, isophthalic acid, terephthalic acid and the isomeric naphthalenedicarboxylic acids. The polyester polyols are obtained by condensation of these polybasic carboxylic acids with polyhydric alcohols, preferably with diols or triols having 2 to 12, more preferably 2 to 6, carbon atoms, preferably trimethylolpropane and glycerol.

It is possible to use polyether polycarbonate polyols, for example. These are polyols containing carbon dioxide in the bonded form of the carbonate. Since carbon dioxide is formed in large amounts as a by-product in many processes in the chemical industry, the use of carbon dioxide as comonomer in alkylene oxide polymerizations is of particular interest from a commercial viewpoint. Partial replacement of alkylene oxides in polyols with carbon dioxide has the potential to distinctly lower costs for the production of polyols.

Moreover, the use of CO₂ as comonomer is environmentally very advantageous, since this reaction constitutes the conversion of a greenhouse gas into a polymer. The preparation of polyether polycarbonate polyols by addition of alkylene oxides and carbon dioxide onto H-functional starter substances with the use of catalysts has long been known. Various catalyst systems may be employed here: The first generation was that of heterogeneous zinc or aluminium salts, as described, for example, in U.S. Pat. No. 3,900,424 or U.S. Pat. No. 3,953,383. In addition, mono- and binuclear metal complexes have been successfully used for copolymerization of CO₂ and alkylene oxides (WO 2010/028362, WO 2009/130470, WO 2013/022932 or WO 2011/163133). The most important class of catalyst systems for the copolymerization of carbon dioxide and alkylene oxides is that of double metal cyanide catalysts, also referred to as DMC catalysts (U.S. Pat. No. 4,500,704, WO 2008/058913). Suitable alkylene oxides and H-functional starter substances are those also used for preparing carbonate-free polyether polyols, as described above.

It is possible, for example, to use polyols based on renewable raw materials, “natural oil-based polyols” (NOPs). NOPs for production of polyurethane foams are of increasing interest with regard to the limited availability in the long term of fossil resources, namely oil, coal and gas, and against the background of rising crude oil prices, and have already been described many times in such applications (WO 2005/033167: US 2006/0293400, WO 2006/094227, WO 2004/096882, US 2002/0103091, WO 2006/116456 and EP 1678232). A number of such polyols are now available on the market from various manufacturers (WO2004/020497, US2006/0229375, WO2009/058367). Depending on the base raw material (e.g. soybean oil, palm oil or castor oil) and subsequent processing, polyols having different profiles of properties are obtained. A distinction may essentially be made between two groups: a) polyols based on renewable raw materials that are modified such that they may be used to an extent of 100% in the production of polyurethanes (WO2004/020497. US2006/0229375); b) polyols based on renewable raw materials that on account of their processing and properties are able to replace the petrochemical-based polyol only up to a certain proportion (WO2009/058367).

A further class of polyols which can be used is for example that of the “filled polyols” (polymer polyols). The characteristic feature of these is that they contain dispersed solid organic fillers up to a solids content of 40% or more. Usable polyols include SAN. PUD and PIPA polyols. SAN polyols are highly reactive polyols containing a dispersed copolymer based on styrene-acrylonitrile (SAN). PUD polyols are highly reactive polyols containing polyurea, likewise in dispersed form. PIPA polyols are highly reactive polyols containing a dispersed polyurethane, for example formed by in situ reaction of an isocyanate with an alkanolamine in a conventional polyol.

A preferred ratio of isocyanate and polyol, expressed as the index of the formulation, i.e. as the stoichiometric ratio of isocyanate groups to isocyanate-reactive groups (e.g. OH groups, NH groups) multiplied by 100, is in the range from 10 to 1000, preferably 40 to 700, more preferably 50 to 600, especially preferably 60 to 550. An index of 100 represents a molar ratio of reactive groups of 1:1.

Isocyanates b) used are preferably one or more organic polyisocyanates having two or more isocyanate functions. Polyols used are preferably one or more polyols having two or more isocyanate-reactive groups.

Isocyanates b) suitable for the purposes of the this invention are all isocyanates containing at least two isocyanate groups. It is generally possible to use all aliphatic, cycloaliphatic, arylaliphatic and preferably aromatic polyfunctional isocyanates known per se. Particular preference is given to using isocyanates within a range from 60 to 200 mol % relative to the sum total of the isocyanate-consuming components.

Specific examples here are alkylene diisocyanates having 4 to 12 carbon atoms in the alkylene radical. e.g. dodecane 1,12-diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate (HMDI), cycloaliphatic diisocyanates such as cyclohexane 1,3- and 1,4-diisocyanate and also any mixtures of these isomers, 1-isocyanato-3,3,5-trimethyl-5-isocyanatomethylcyclohexane (isophorone diisocyanate or IPDI for short), hexahydrotolylene 2,4- and 2,6-diisocyanate and also the corresponding isomer mixtures, and preferably aromatic diisocyanates and polyisocyanates, for example toluene 2,4- and 2,6-diisocyanate (TDI) and the corresponding isomer mixtures, naphthalene diisocyanate, diethyltoluene diisocyanate, mixtures of diphenylmethane 2,4′- and 2,2′-diisocyanates (MDI) and polyphenylpolymethylene polyisocyanates (crude MDI) and mixtures of crude MDI and toluene diisocyanates (TDI). The organic diisocyanates and polyisocyanates may be used individually or in the form of mixtures thereof. It is likewise possible to use corresponding “oligomers” of the diisocyanates (IPDI trimer based on isocyanurate, biurets, uretdiones). In addition, the use of prepolymers based on the abovementioned isocyanates is possible.

It is also possible to use isocyanates which have been modified by the incorporation of urethane, uretdione, isocyanurate, allophanate and other groups, called modified isocyanates.

Usable organic polyisocyanates that are particularly suitable and therefore may be used with particular preference within the context of a preferred embodiment of the invention are various isomers of toluene diisocyanate (toluene 2,4- and 2,6-diisocyanate (TDI), in pure form or as isomer mixtures of varying composition), diphenylmethane 4,4′-diisocyanate (MDI). “crude MDI” or “polymeric MDI” (comprising the 4,4′ isomer and also the 2,4′ and 2,2′ isomers of MDI and products having more than two rings) and also the two-ring product referred to as “pure MDI” that is composed predominantly of 2,4′ and 4,4′ isomer mixtures, and prepolymers derived therefrom. Examples of particularly suitable isocyanates are detailed, for example, in EP 1712578, EP 1161474, WO 00/58383, US 2007/0072951, EP 1678232 and WO 2005/085310, which are hereby fully incorporated by reference.

Suitable catalysts d) in the context of the present invention are all compounds capable of accelerating the reaction of isocyanates with OH functions, NH functions or other isocyanate-reactive groups and with isocyanates themselves. It is possible here with preference to make use of the customary catalysts known from the prior art, including, for example, amines (cyclic, acyclic; monoamines, diamines, oligomers having one or more amino groups), ammonium compounds, organometallic compounds and metal salts, preferably those of potassium, tin, iron, zinc or bismuth. In particular, as catalysts it is possible to use mixtures of more than one component.

As component e) it is possible for example to use Si-free surfactants or else for example organomodified siloxanes.

The use of such substances in rigid foams is known. In the context of this invention, it is possible here to use all compounds that assist foam production (stabilization, cell regulation, cell opening, etc.). These compounds are sufficiently well known from the prior art.

Corresponding siloxanes usable in the context of this invention are described, for example, in the following patent specifications: CN 103665385. CN 103657518, CN 103055759, CN 103044687. US 2008/0125503, US 2015/0057384, EP 1520870 A1. EP 1211279, EP 0867464, EP 0867465, EP 0275563. The abovementioned documents are hereby incorporated by reference and are considered to form part of the disclosure content of the present invention. The use of polyether-modified siloxanes is particularly preferred.

The use of blowing agents f) is optional, according to which foaming process is used. It is possible to work with chemical and physical blowing agents. The choice of blowing agent is here strongly dependent on the nature of the system.

In a particularly preferred embodiment, no HFOs are used as blowing agent.

Optional physical blowing agents used may be corresponding compounds having appropriate boiling points. It is likewise optionally possible to use chemical blowing agents which react with NCO groups to liberate gases, for example water or formic acid. Examples of blowing agents are liquefied CO2, nitrogen, air, volatile liquids, for example hydrocarbons having 3, 4 or 5 carbon atoms, preferably cyclo-, iso- and n-pentane, hydrofluorocarbons, preferably HFC 245fa, HFC 134a and HFC 365mfc, hydrochlorofluorocarbons, preferably HCFC 141b, hydrofluoroolefins (HFOs) or hydrohaloolefins such as for example 1234ze, 1234yf, 1233zd(E) or 1336mzz, oxygen-containing compounds such as methyl formate, acetone and dimethoxymethane, or chlorinated hydrocarbons, preferably dichloromethane and 1,2-dichloroethane.

Suitable water contents for the purposes of this invention depend on whether or not one or more blowing agents are used in addition to the water. In the case of purely water-blown foams the values are preferably 1 to 30 pphp; when other blowing agents are additionally used the amount of water used is reduced to preferably 0.1 to 5 pphp.

Preference is given to purely water-blown foam formulations, and therefore in this case the proportions of physical blowing agents are very low or these are preferably not present.

Optional additives g) that may be used include all substances which are known from the prior art and are used in the production of polyurethanes, especially polyurethane foams, for example crosslinkers and chain extenders, stabilizers against oxidative degradation (known as antioxidants), flame retardants, surfactants, biocides, cell-refining additives, cell openers, solid fillers, antistatic additives, nucleating agents, thickeners, dyes, pigments, colour pastes, fragrances, and emulsifiers, etc.

The process according to the invention for producing rigid PU or PIR foams can be conducted by the known methods, for example by manual mixing or preferably by means of foaming machines. If the process is carried out by using foaming machines, it is possible to use high-pressure or low-pressure machines. The process according to the invention can be carried out either batchwise or continuously.

A preferred rigid polyurethane or polyisocyanurate foam formulation in the context of this invention results in a foam density of 5 to 900 kg/m³ and preferably has the composition shown in Table 1.

TABLE 1
Composition of a preferred rigid polyurethane
or polyisocyanurate foam formulation

| | Proportion by |
|---|---|
| Component | weight |
| Polyol | 0.1 to 100 |
| Amine catalyst | 0 to 10 |
| Additional catalysts | 0 to 10 |
| Emulsifier according to the invention | 0.1 to 20 |
| Foam stabilizer (Si-free or Si-containing) | 0 to 5 |
| Water | 0.1 to 30 |
| Blowing agent | 0 to 40 |
| Further additives (flame retardants, etc.) | 0 to 90 |
| Isocyanate index: 10 to 1000 | |

For further preferred embodiments and configurations of the process according to the invention, reference is also made to the details already given above in connection with the composition according to the invention.

As already mentioned, the invention further provides a rigid PU or PIR foam obtainable by the process mentioned.

Rigid PU or PIR foam is an established technical term. The known and fundamental difference between flexible foam and rigid foam is that flexible foam shows elastic characteristics and hence deformation is reversible. By contrast, rigid foam is permanently deformed. In the context of the present invention, rigid PU or PIR foam is especially understood to mean a foam according to DIN 7726:1982-05 that has a compressive strength according to DIN 53421:1984-06 and/or DIN EN ISO 604:2003-12 of advantageously ≥20 kPa, by preference ≥80 kPa, preferably ≥100 kPa, more preferably ≥150 kPa, particularly preferably ≥180 kPa.

In a further preferred embodiment, an open-cell foam is produced by the process according to the invention.

The foams to be produced in accordance with the invention have densities of preferably 3 kg/m³ to 300 kg/m³, by preference 4 to 250, particularly preferably 5 to 200 kg/m³, especially 7 to 150 kg/m³. Open-cell foams may be obtained in particular. Particularly preferred open-cell rigid PU or PIR foams in the context of this invention have densities of ≤25 kg/m³, preferably ≤20 kg/m, particularly preferably ≤15 kg/m³, especially ≤10 kg/m³. These low foam densities are often sought in spray foams.

The closed-cell content, and hence the open-cell content, in the context of this invention, is preferably determined in accordance with DIN ISO 4590:2016-12 by pycnometer.

DIN 14315-1:2013-04 sets out various specifications for PU foam, sprayable PU foam therein, also called spray foam. The foams are also classified here—among other parameters—by their closed-cell content.

| Level | Proportion of closed cells |
|---|---|
| CCC1 | <20% |
| CCC2 | 20 to 80% |
| CCC3 | >80 to 89% |
| CCC4 | ≥90% |

In general, better lambda values are achieved with comparatively closed-cell foams (CCC3 and CCC4) than with comparatively open-cell foams (CCC1 and CCC2). While an open-cell foam is producible with low densities, a closed-cell foam requires a higher density in order for the polymer matrix to be stable enough to withstand the atmospheric pressure.

Preferred PU or PIR foams in the context of the present invention are open-cell rigid PU or PIR foams. Open-cell rigid PU or PIR foams in the context of this invention advantageously have a proportion of closed cells of ≤50%, preferably ≤20% and especially ≤10%, the closed-cell content in the context of this invention preferably being determined according to DIN ISO 4590:2016-12 by pycnometer. This means that these foams are covered by the categories CCC2 or preferably CCC1 according to the specification of DIN 14315-1:2013-04.

The rigid PU or PIR foams according to the invention can be used as or for production of insulation materials, insulating foams, roof liners, packaging foams or spray foams.

The invention further provides for the use of the rigid PU or PIR foam as insulation material in refrigeration technology, in refrigeration equipment, in the construction sector, automobile sector, shipbuilding sector and/or electronics sector, as spray foam.

The subject matter of the invention has been described above and is described by way of example hereinafter, without any intention that the invention be restricted to these illustrative embodiments. Where ranges, general formulae or classes of compounds are stated, these are intended to encompass not only the corresponding ranges or groups of compounds explicitly mentioned but also all subranges and subgroups of compounds that can be obtained by removing individual values (ranges) or compounds. Where documents are cited in the context of the present description, the entire content thereof, particularly with regard to the subject matter that forms the context in which the document has been cited, is intended to form part of the disclosure content of the present invention. Unless stated otherwise, percentages are in weight percent. Where average values are stated, these are weight averages unless stated otherwise. Where parameters that have been determined by measurement are stated, the measurements have been carried out at a temperature of 25° C. and a pressure of 101 325 Pa, unless stated otherwise.

The examples which follow describe the present invention by way of example, without any intention of restricting the invention, the scope of application of which is apparent from the entirety of the description and the claims, to the embodiments cited in the examples.

### EXAMPLES

Isocyanate-reactive compositions were produced using the following raw materials:
Polyether polyol having a molar mass of 6000 g/mol, a functionality of 3, with primary OH groups.
Fyrol TCPP: tris(2-chloroisopropyl) phosphate from ICL
POLYCAT® 31 from Evonik Operations GmbH, amine catalyst
POLYCAT®140 from Evonik Operations GmbH, amine catalyst
POLYCAT®142 from Evonik Operations GmbH, amine catalyst
TEGOSTAB® B 8580 from Evonik Operations GmbH, foam-stabilizing Si surfactant

### Emulsifiers:

The alkoxylates described here can be prepared by the known methods.

Emulsifier A (noninventive)

Isotridecanol with 6 EO units per OH function

Emulsifier B: naphthol-based (Inventive):

2-Naphthol with 11 ethylene oxide units per OH function.

### Emulsifier C (Inventive):

Mixture of phenol with 4 ethylene oxide units per OH function and 2-naphthol with 11 ethylene oxide units per OH function in a ratio of 2:8.

### Emulsifier D (Inventive):

Mixture of phenol with 4 ethylene oxide units per OH function, 2-naphthol with 11 ethylene oxide units per OH function and water in a ratio of 17:78:5.

### Emulsifier E (Inventive)

4-Cumylphenol with 12 ethylene oxide units per OH function.

### Examples

### Preparation of Isocyanate-Reactive Mixtures

| Formulation | Form. 1 | Form. 2 | Form. 3 | Form. 4 | Form. 5 |
|---|---|---|---|---|---|
| Polyol, (MW 6000, | 31 | 31 | 31 | 31 | |
| trifunctional) | | | | | |
| TCPP | 24 | 24 | 24 | 24 | |
| Water | 18 | 18 | 18 | 18 | |
| POLYCAT ® 31 | 1 | 1 | 1 | 1 | |
| POLYCAT ® 140 | 6 | 6 | 6 | 6 | |
| POLYCAT ® 142 | 1 | 1 | 1 | 1 | |
| TEGOSTAB ® B | 1 | 1 | 1 | 1 | |
| 8580 | | | | | |
| Emulsifier A | 7.5 | | | | |
| Emulsifier B | | 7.5 | | | |
| Emulsifier C | | | 7.5 | | |
| Emulsifier D | | | | 7.5 | |
| Emulsifier E | | | | | 7.5 |
| Storage for 14 days | | | | | |
| Appearance | Cloudy | Clear | Clear | Clear | Clear |
| Phase separation | Yes, 3 ml | None | None | None | None |

The components described in the table (values in parts by weight) were weighed into a beaker and mixed with a disc stirrer (diameter 6 cm) at 1000 rpm for 30 s. 50 ml of these mixtures were then transferred into sealable graduated glass measuring cylinders, so that the mixtures can be observed and no blowing agent can evaporate during the storage time. In the event of occurrence of phase separation, the graduation can be used to easily read off the layer thickness of the separated phase via the graduation.

The isocyanate-reactive compositions according to the invention with emulsifiers B to E do not exhibit any phase separation after storage at room temperature for 14 days.

1. A process for producing a rigid PU or PIR foam, the process comprising:
contacting at least one isocyanate with an isocyanate-reactive mixture comprising at least one polyol, water and at least one emulsifier, wherein one or more organic polyisocyanates having two or more isocyanate functions are used as isocyanates,
wherein the at least one emulsifier comprises at least one alkoxylated aromatic alcohol, in which a parent aromatic alcohol has at least 6 and at most 40 carbon atoms and also at least one OH function, and in which at most ⅕ of carbon atoms of the parent aromatic alcohol are not aromatic, and
wherein at least one aromatic unit in the parent aromatic alcohol must bear an OH function.

2. The process according to claim 1, wherein the aromatic alcohol is ethoxylated.

3. The process according to claim 1, wherein the at least one alkoxylated aromatic alcohol is based on
(i) a monocyclic aromatic alcohol having one or more OH functions,
(ii) a polycyclic aromatic system having one or more OH functions,
(iii) a linked aromatic system having one or more OH functions,
and/or
(iv) a styrenized phenols.

4. The process according to claim 1, wherein at least two alkoxylated aromatic alcohols are used.

5. The process according to claim 1, wherein the at least one alkoxylated aromatic alcohol used has 4 to 100 alkoxy groups per molecule.

6. The process according to claim 1, wherein the at least one alkoxylated aromatic alcohol used has a calculated HLB value of between 10 and 20.

7. The process according to claim 1, wherein the isocyanate-reactive mixture contains 2% to 30% by mass of water and 1% to 30% by mass of the at least one emulsifier and, if any, less than 3% by mass of nonylphenol ethoxylate.

8. The process according to claim 1, wherein the isocyanate-reactive mixture further comprises flame retardants.

9. The process according to claim 1, wherein the isocyanate-reactive mixture further comprises at least one catalyst.

10. A composition, comprising:
an isocyanate-reactive mixture which comprises at least one polyol, water, and at least one alkoxylated aromatic alcohol, in which a parent aromatic alcohol has at least 6 and at most 40 carbon atoms and also at least one OH function, and in which at most ⅕ of carbon atoms of the parent aromatic alcohol are not aromatic, and wherein at least one aromatic unit in the parent aromatic alcohol must bear an OH function and
wherein the isocyanate-reactive mixture comprises 2% to 30% by mass of water and 1% to 30% by mass of at least one emulsifier and, if any, less than 3% by mass of nonylphenol ethoxylates, and optionally contains flame retardants.

11. An emulsifier-containing formulation, comprising:
(a) at least one alkoxylated aromatic alcohol in which a parent aromatic alcohol has at least 6 and at most 40 carbon atoms and also at least one OH function, and in which at most ⅕ of carbon atoms of the parent aromatic alcohol are not aromatic, and wherein at least one aromatic unit in the parent aromatic alcohol must bear an OH function, in an amounts of from 20% to <100% by weight,
(b) water in a amounts of from 0% to 30% by weight, and
(c) a carrier medium in an amount of from 0% to 80% by weight,
with the proviso that the sum total of (b) and (c) is >0% by weight.

12. A method for improving the storage stability of an isocyanate-reactive mixture comprising polyols, water, and optionally flame retardants, the method comprising:
emulsifying at least one alkoxylated aromatic alcohol(s), in which a parent aromatic alcohol has at least 6 and at most 40 carbon atoms and also at least one OH function, and in which at most ⅕ of carbon atoms of the parent aromatic alcohol are not aromatic, and wherein at least one aromatic unit in the parent aromatic alcohol must bear an OH function with the isocyanate-reactive mixture comprising polyols, water, and optionally flame retardants.

13. A rigid PU or PIR foam, produced by the process according to claim 1.

14. A rigid PU or PIR foam, which is an open-cell, water-blown spray foam.

15. The process according to claim 3, wherein the monocyclic aromatic alcohol having one or more OH functions is at least one selected from the group consisting of phenol, pyrocatechol, and resorcinol.

16. The process according to claim 3, wherein the polycyclic aromatic system having one or more OH functions is at least one selected from the group consisting of 1-naphthol and 2-naphthol.

17. The process according to claim 3, wherein the linked aromatic system having one or more OH functions is at least one selected from the group consisting of cumylphenol, biphenol, bisphenol A, and bisphenol F.

18. The process according to claim 3, wherein the styrenized phenol is at least one selected from the group consisting of 2,4,6-tris(1-phenylethyl)phenol, 2,4-bis(1-phenylethyl)phenol, and p-(1-phenylethyl)phenol.

19. The process according to claim 4, wherein the at least two alkoxylated aromatic alcohols comprise ethoxylated phenol(s) and ethoxylated naphthol(s).

20. The process according to claim 6, wherein the calculated HLB value is greater than 14.
